(19) United States
(12) Patent Application Publication
(10) Pub. No.: US 2005/0118451 A1
(43) Pub. Date: Jun. 2, 2005

(54) Heat shield for a catalytic converter

(75) Inventors: Hang Li, Farmington Hills, MI (US); Madhavan Narayanan, Farmington Hills, MI (US); William Ray Koivula, Milford, MI (US); Niladri Das, Canton, MI (US); Robert James Sanderson JR., Browntown Township, MI (US)

Correspondence Address: BRINKS HOFER GILSON & LIONE/CHICAGO/COOK, PO BOX 10395, CHICAGO, IL, 60610, US

(73) Assignee: Visteon Global Technologies, Inc.

(21) Appl. No.: 10/725,870

(22) Filed: Dec. 2, 2003

(51) Int. Cl. B32B 15/20

(52) U.S. Cl. 428/653; 428/937; 428/685

(57) ABSTRACT

A heat shield for a catalytic converter includes a substrate and a coating made from Al—Si. The coating is applied to the substrate to form a mechanical bond between the substrate and the coating to provide a damping layer to reduce the peak resonances of the heat shield

### BACKGROUND

1. Technical Field

The present invention relates generally to catalytic converters, and more particularly relates to heat shields for catalytic converters.

2. Background Information

The exhaust system of most, if not all, automotive vehicles are provided with catalytic converters that reburn unburned gas coming from the engine. More specifically, the catalytic converter contains a material that acts as a catalyst to convert most unburned hydrocarbons and carbon monoxide into water vapor, carbon dioxide, NOx and lesser toxic gases.

Since catalytic converters operate at very high temperatures, they are typically provided with an external heat shield. However, it has been found that these heat shields produce a significant component of NVH originating from the exhaust system. For example, catalytic converter systems with a heat shield may produce at least several dB higher noise levels than systems without heat shields. Therefore, original equipment manufacturers are willing to pay and are demanding for improved heat shields that significantly reduce the noise from the exhaust system related to NVH.

To reduce NVH, a liner mechanically keyed to the inside surface of a heat shield made from, for example, stamp sheet metal, have been used in the past. This liner typically consists of a stainless steel sheet, a stainless steel foil, and a layer of ceramic fiber material. Such structures are not only expensive to manufacture but it are also very heavy.

From the above, it is seen that there exists a need a need for an improved vibration damper for heat shields in catalytic converters.

### BRIEF SUMMARY

In overcoming the above mentioned and other drawbacks, the present invention provides an economical and reliable process for producing a vibration damper for an external heat shield of a catalytic converter.

In general, the heat shield is produced by locating areas of maximum resonance by using, for example, laser vibration scans or computer aided engineering (“CAE”) vibration analysis, and then applying an Al—Si porous coating on these areas. The Al—Si coating can be applied with a flame, spraying process, to a substrate, such as stainless steel. The composition of the Al—Si can be in the range of about Al—Si 4% to Al—Si 18%. In some implementations, the composition is about Al—Si 12%.

The reduction in the peak resonance frequencies can be optimized by appropriately selecting the pattern, location, size, and thickness of the coating.

This new approach of using thermal spray Al—Si porous coating on a catalytic converter heat shield for improving the NVH properties of the heat shield may have one or more of the following advantages:
Increased durability: Thermal sprayed Al—Si porous coating on a substrate, such as 409 stainless steel, has excellent adhesion properties. For example, the Al—Si coating/409 stainless steel laminate can withstand a 400° C. water quench thermal shock test and pass a 90° angle 10 mm radius bending test without breaking the bond between the coating and steel substrate.
Increased effectiveness: By properly selecting the coating thickness, coating pattern, coating size and coating location, the Al—Si coating significantly damps the heat shield vibration and improves the NVH performance of the catalytic converter. The coating process facilitates the use of laser vibration scan results (or CAE analysis) to determine critical coating factors to increase design and manufacturing capabilities for the production of heat shields.
Weight reduction: For certain embodiments, the Al—Si porous coating application increases the weight of the heat shield by only about 10%. On the other hand, certain conventional three-layer liners can increase the weight of heat shield by over 50%.
Low cost: A flame spray cell for mass production of the heat shields has particular cost advantages, since the coating material cost per component is relatively low while the productivity of the process is relatively high, if proper spray system is selected. For the sake of comparison, the cost of a three-layer line comes mostly from the material, and therefore makes any cost reduction in the production process of the liner difficult.
Al—Si alloy coating applied to stainless steel, such as SS409, sheet metal provides additional high temperature corrosion protection.

Other embodiments and advantages will be apparent from the following drawings, detailed description, and claims.

### BRIEF DESCRIPTION OF THE DRAWINGS

The accompanying drawings, incorporated in and forming a part of the specification, illustrate several aspects of the present invention. The components in the figures are not necessarily to scale, emphasis instead being placed upon illustrating the principles of the invention. Moreover, in the figures, like reference numerals designate corresponding parts throughout the views. In the drawings:

FIG. 1 depicts a portion of a catalytic converter heat shield coated with porous Al—Si in accordance with the invention;

FIG. 2 is a phase diagram for the Al—Si binary system;

FIG. 3 depicts the results of a laser vibration scan test of an exhaust system;

FIG. 4 depicts the results of a sound pressure mapping test of the exhaust system;

FIG. 5A illustrates a heat shield sample with an Al—Si coating having a smaller pattern;

FIG. 5B illustrates a heat shield sample with an Al—Si coating having a larger pattern;

FIG. 5C illustrates a heat shield sample without a coating;

FIG. 6 illustrates a comparison of the acceleration frequency response functions between the heat shield sample with the Al—Si coating having the larger pattern and the heat shield sample without the coating;

FIG. 7 illustrates a comparison of the sound pressure frequency response functions between the heat shield sample with the Al—Si coating having the larger pattern and the heat shield sample without the coating;

FIG. 8A illustrates the sound pressure spectrum for the heat shield sample with the Al—Si coating having the larger pattern; and

FIG. 8B illustrates the sound pressure spectrum for the heat shield sample without the coating.

### DETAILED DESCRIPTION

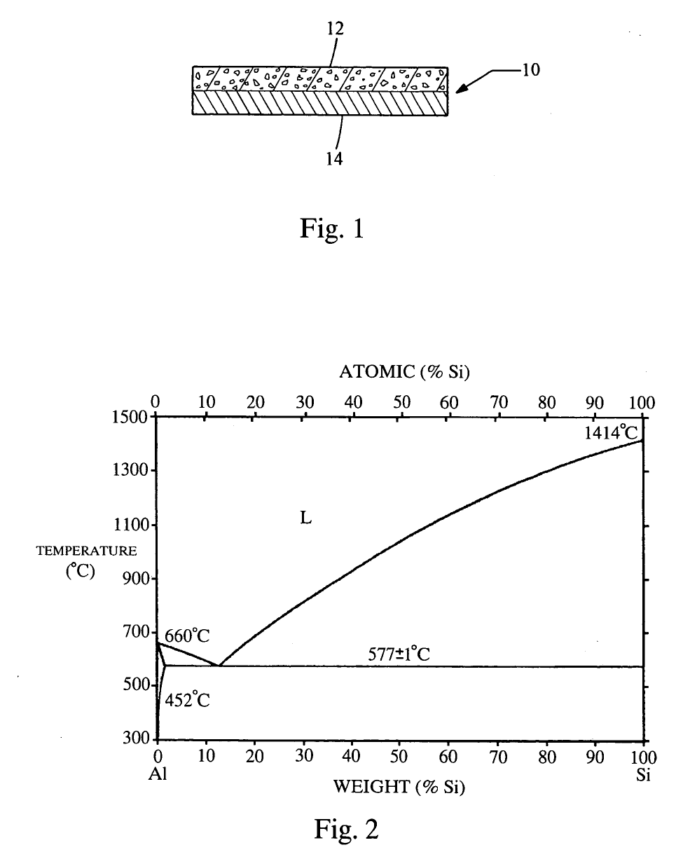

In accordance with the invention, a coating for a heat shield 10, a portion of which is shown in FIG. 1 is produced by applying an Al—Si binary eutectic material on a substrate 14. The heat shield can be used in any applications in which the heat shield is exposed to high temperatures. For example, in certain implementations, the heat shield is used for catalytic converters commonly found in vehicle exhaust systems. The substrate 14 can be made of stainless steel, such as 409 stainless steel. The Al—Si composition can be in the range of about Al—Si 4% to Al—Si 18%. In certain implementations, the composition is Al—Si 12%, indicating that the amount of Si is about 12%. As discussed below, this shield provides significantly better vibration damping performance over conventional type heat shields. Moreover, the shield 10 can be produced at a lower cost than conventional type shields.

Al—Si (for which the binary Al—Si mapping is shown in FIG. 2) provides the following benefits:
The Al—Si is resistant to corrosion at the high temperatures typically experienced by muffler systems.
The thermal expansion differential between an Al—Si binary porous coating and most substrates, such as 409 stainless steel, is small, thereby providing better adhesion performance under thermal cycling conditions typically experienced by a muffler system.
Al—Si can withstand high temperatures, for example, greater than 500° C., which is significantly higher than the typical peak temperature (less than 400° C.) the heat shield experiences.
The Al—Si alloy is light in weight and adding porosity further reduces the weight of the coating system.

Prior to the coating process, the substrate undergoes a treatment process to clean the substrate surface of oil and is sandblasted to a desired roughness. To apply the Al—Si to the substrate, a thermal spray can be employed as the coating method. Since aluminum alloy does not form a ductile metallurgical bond with stainless steel and vibration damping requires a thick and soft coating (i.e, a soft material with porosity), thermal spray coating, such as flame spray is an appropriate process to form the coating-substrate bond and to deliver the coating material in a manner to build up the thickness of the coating at a desirable rate. Either thermal spray powder or thermal spray wire can be selected to apply Al—Si porous coating to a stainless steel substrate, such as the substrate 14.

Since the thickness of the coating 12 can be equal to or thicker than the thickness of the substrate 14, the coated area actually becomes a laminated composite structure in which a hard layer of the substrate 14 bonds with a soft layer of porous Al—Si material 12, thereby providing a structure with desirable vibration damping capabilities.

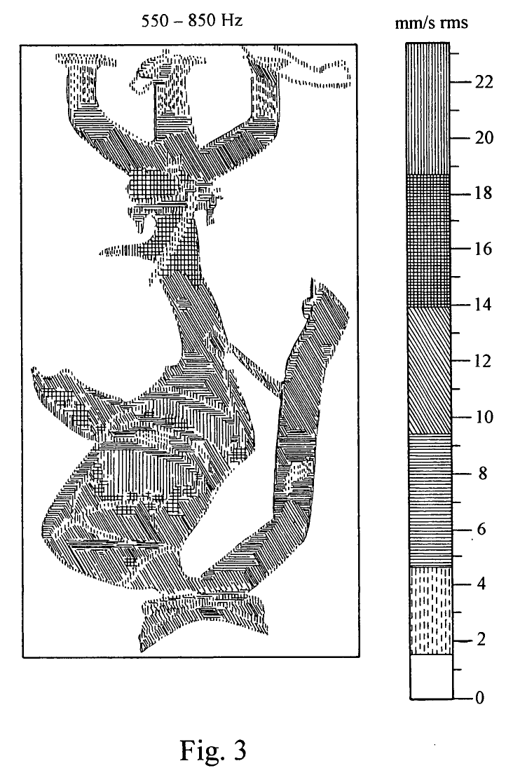

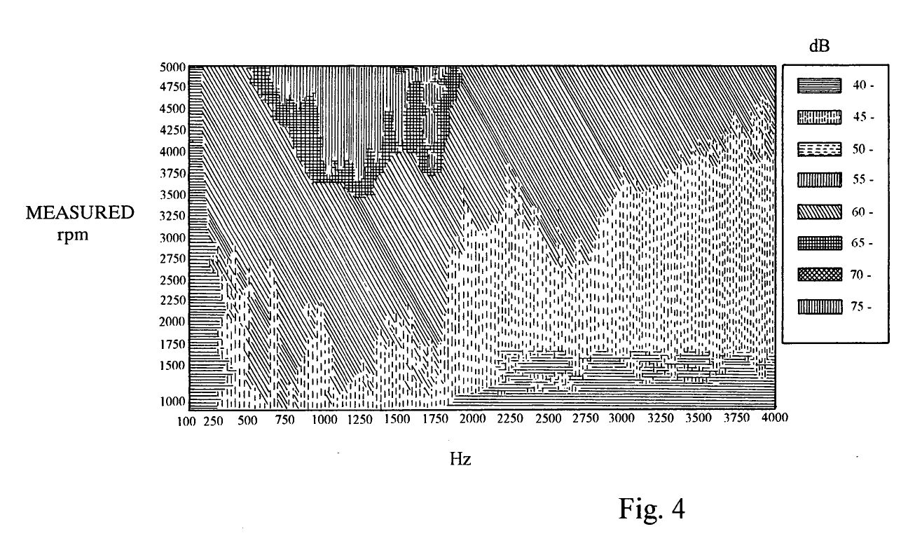

The coating 12 is typically not applied to the entire outer surface of the heat shield, but rather at the locations where the heat shield experiences a high level of vibration. To determine these locations, tests were conducted, for example, using a vibration laser scan measurement technique and sound pressure recording on a heat shield attached to a catalytic converter of muffler system of a running engine. For example, laser vibration scan results are shown schematically in FIG. 3, and the results for the sound pressure mapping are illustrated schematically in FIG. 4. In this example, the tests indicated that the center section at the floating end of the heat shield produced the highest level of vibration. In this region, the vibration resonance frequency is in the range between about 1,050 Hz to 1,550 Hz.

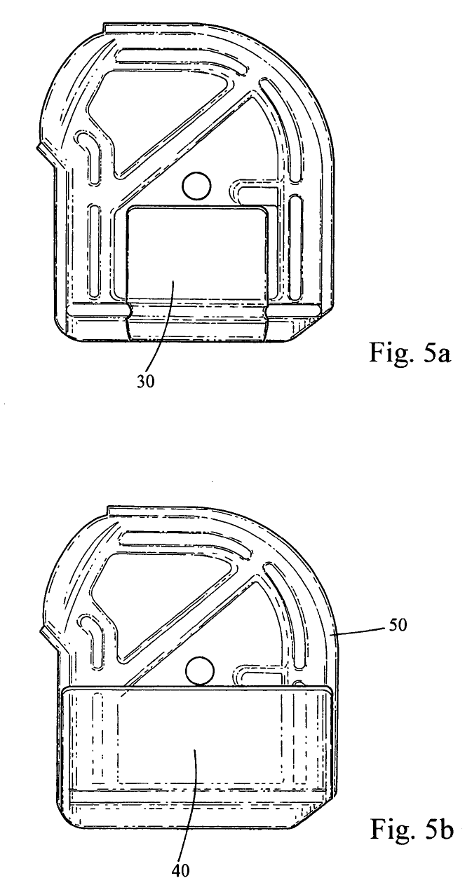

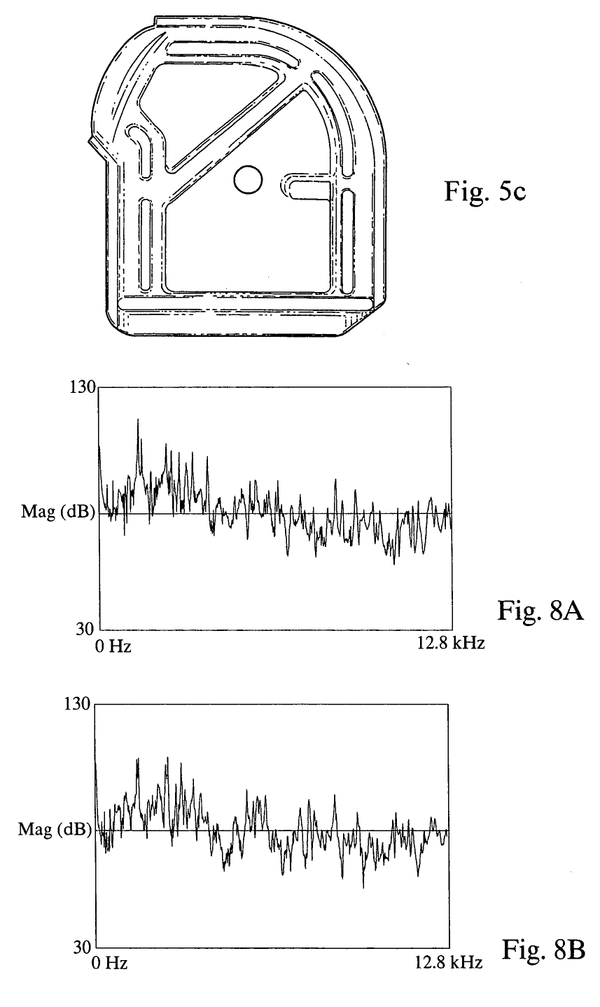

Accordingly, to damp the high level of vibration at the floating end of the heat shield, the location, pattern, and size of two coating patterns were selected based on the laser vibration scan results. One coating pattern, illustrated as a small pattern 30 in FIG. 5A, was about 3 inches wide and about 3 inches long, and the other coating pattern, depicted as a larger pattern 40 in FIG. 5B, was about 3 inches wide and about 7 inches long. Moreover for each of the large and small patterns, two coating thickness were selected: 0.04 inch and 0.06 inch. Thus, a total of four heat shield samples were further examined.

To evaluate the durability of the porous coating material, such as Al—Si 12%, two coupons with the smaller pattern and different coating thicknesses, 0.04 inch and 0.06 inch, were produced and subjected to a thermal shock test and to a destructive cold bending test. For the thermal shock test, the coupons were repeatedly heated to 400° C. in an oven and then quenched in water. After 100 cycles, the coupons were visually inspected for any cracks and coating-substrate separation damage. Neither the 0.04 inch nor the 0.06 inch coatings experienced cracking or coating-substrate separation damage.

For the cold bending test, a coupon with a 0.04 inch coating and a coupon with a 0.06 inch coating were subjected to a 90° bending test. The test results indicate that the 0.04 inch coating withstood the cold bending test without any damage (neither within the coating nor at the coating/substrate interface). Although there was no damage at the coating-substrate interface in the 0.06 inch coating, some coating surface material chipping was observed.

Component level vibration and NVH tests were also conducted on the four aforementioned heat shield samples. Each sample was suspended from a frame using rubber surgical tubing. A modal hamper was used to provide the force input into the sample, for example, at the location 50 shown in FIG. 5B. The response was measured by a microphone mounted about 20 cm away from the sample and by an accelerometer magnetically attached to the underside of the sample at the coating location.

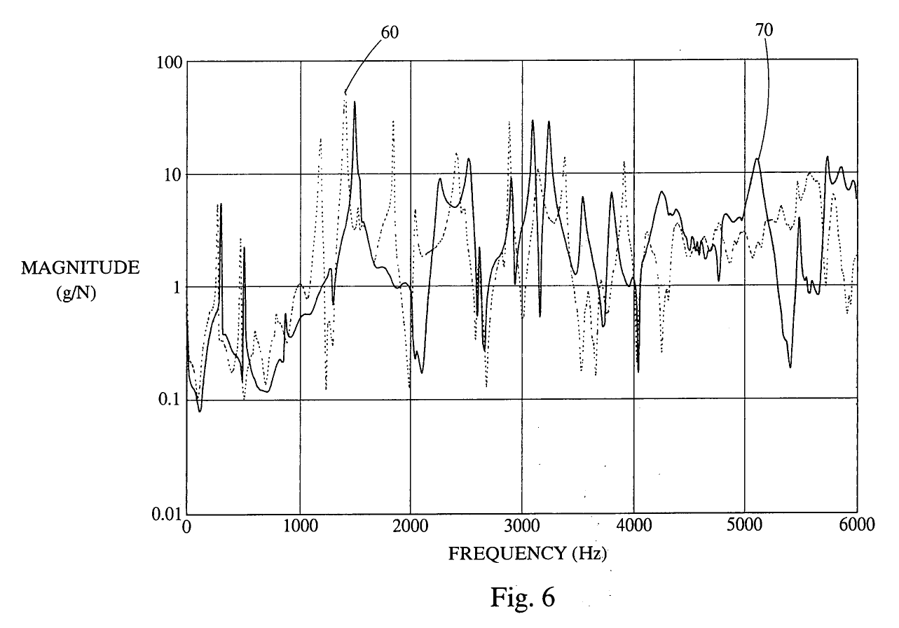

Among the four samples that were coated with the Al—Si 12% material, the 0.04 inch, 3 inches×7 inches (FIG. 5B) patch exhibited desirable comprehensive performance. The performance of this sample was also compared with that of a production type of heat shield without a coating to provide a base comparison, as presented in FIGS. 6 through 8.

FIG. 6 shows the comparison of the acceleration frequency response functions between the heat shield with the 0.04 inch, 3 inch×7 inch patch (FIG. 5B), identified by the reference numeral 70, and the uncoated sample (FIG. 5C), identified by the reference numeral 60. Since sound pressure measurement identified heat shield vibration problems occurring in a low frequency range between 1050 Hz and 1,550 Hz, attention was given to the effect of Al—Si porous coating on the low frequency spectrums of the vibration spectral plots of FIG. 6. As indicated in FIG. 6, the coating significantly reduces heat shield vibration in the frequency range between 1,000 Hz and 1,850 Hz. Moreover, the coating application not only reduces the number of major resonance peaks in the low frequency range but also lowers the amplitude of the resonance peaks.

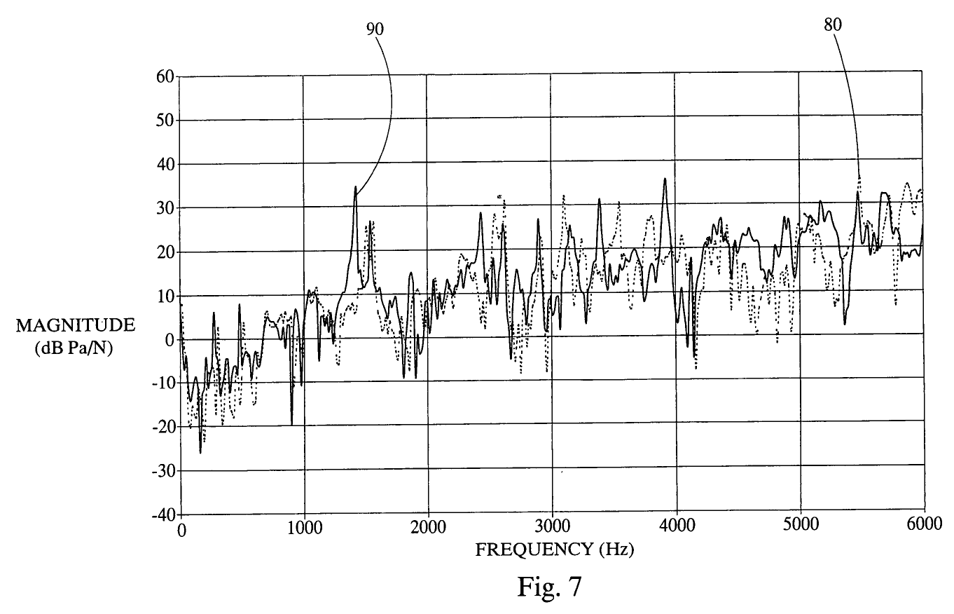

FIG. 7 illustrates the comparison between the sound pressure frequency response functions of the sample with the 0.04 inch, 3 inches×7 inches patch (FIG. 5B), identified by the reference numeral 80, and that of the uncoated sample (FIG. 5C), identified by the reference numeral 90. As can be seen, the coating reduces the normalized noise level by a factor of about six. Thus, again the coating significantly lowers the magnitude of the peak sound pressure in the 1,000 to 1,850 Hz range.

FIGS. 8A and 8B illustrate the sound pressure power spectrums generated from the uncoated sample and the sample with the 0.04 inch, 3 inches×7 inches (FIG. 5B) patch, respectively. The results indicate that the maximum resonance sound pressure for both components occurs at 1,500 Hz frequency. Comparing the maximum sound pressure peak for both spectrums, it is easily seen that over a 7 dB sound pressure reduction of the maximum sound pressure is achieved with the coating.

It is therefore intended that the foregoing detailed description be regarded as illustrative rather than limiting, and that it be understood that it is the following claims, including all equivalents, that are intended to define the spirit and scope of this invention.

1. Method for applying a vibration damping layer to a heat shield, comprising:
locating regions of the heat shield with maximum resonance vibrations; and
applying a porous coating of Al—Si onto the heat shield in the located regions, the coating providing the vibration damping layer.

2. The method of claim 1, wherein the locating includes identifying the regions with a laser vibration scan.

3. The method of claim 1, wherein the locating includes identifying the regions with computer aided engineering vibration analysis.

4. The method of claim 1, wherein the composition of the Al—Si is in the range of about Al—Si 4% to Al—Si 18%.

5. The method of claim 1, wherein the composition of the Al—Si is about Al—Si 12%.

6. The method of claim 1, wherein the heat shield is made of stainless steel.

7. The method of claim 1, wherein the applying includes spraying the Al—Si coating with a thermal spray process.

8. A heat shield for a catalytic converter, comprising:
a substrate; and
a coating made from Al—Si applied to the substrate to form an mechanical bond between the substrate and the coating, the coating providing a damping layer to reduce the peak resonances of the heat shield.

9. The heat shield of claim 9, wherein the substrate is made of stainless steel.

10. The heat shield of claim 9, wherein the coating is made from a eutectic Al—Si composition in the range of about Al—Si 4% to Al—Si 18%.

12. The heat shield of claim 10, wherein the Al—Si composition is about Al—Si 12%.
